(19) United States
(12) Patent Application Publication
(10) Pub. No.: US 2005/0237291 A1
(43) Pub. Date: Oct. 27, 2005

(54) Electro-optical device and electronic apparatus

(75) Inventor: Toru Aoki, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/088,981

(22) Filed: Mar. 24, 2005

(30) Foreign Application Priority Data
Apr. 27, 2004 (JP) 2004-132104

(51) Int. Cl. G09G 3/36

(52) U.S. Cl. 345/100

(57) ABSTRACT

An electro-optical device includes: a plurality of scanning lines; a plurality of data lines; a plurality of pixel units that are electrically connected to the scanning lines and the data lines, respectively, and have display elements, respectively; a plurality of selection switching elements that supply image signals to the data lines, in response to selection signals; a scanning line driving circuit that supplies scanning signals for line-sequentially selecting the plurality of scanning lines to the plurality of scanning lines, respectively; a selection signal supply circuit that, for one scanning line to which the scanning signal is supplied relatively earlier and another scanning line to which the scanning line is supplied relatively later among the plurality of scanning lines, supplies the selection signal to each of the selection switching elements after the supply of the scanning signal to the one scanning line ends and another scanning line is selected by the supply of the scanning signal; and an image signal supply circuit that supplies the image signal to each of the selection switching elements, wherein a period in which the voltage polarity of the image signal is inverted into either a first polarity or a second polarity with respect to a predetermined reference potential corresponds to a time until another scanning line is selected and the supply of the selection signal starts, after the supply of the scanning signal to the one scanning line ends.

### BACKGROUND

The present invention relates to an electro-optical device, such as a liquid crystal device, and an electronic apparatus, such as a liquid crystal projector having the electro-optical device.

One example of such an electro-optical device disclosed in Patent Documents 1 to 6 is a liquid crystal device for performing image display by applying a voltage determined by each potential of a pixel electrode and a counter electrode to a liquid crystal element having liquid crystal, which is one example of electro-optical material, interposed between the pixel electrode and the counter electrode, for each pixel unit. In the liquid crystal device, the liquid crystal element is alternating current (AC) driven as described below, in order to prevent degradation of the liquid crystal device due to application of a direct current (DC) component.

In each pixel unit, a scanning signal is supplied to each scanning line, and an image signal having a voltage inverted into a first polarity or a second polarity is supplied to a data line. Further, for a pixel unit selected by supplying the scanning signal, the liquid crystal element performs image display based on the supplied image signal. Here, for example, for a display of a normally-white mode, a voltage change of the data line is the largest when a black level display is performed by the liquid crystal element, and then, the black level display is performed based on the inverted image signal.

In Patent Documents 1 to 6, prior to displaying images by the liquid crystal element as described above, a data line is precharged, for example, in the following method, i.e., by arranging one type of a selection switching element on the data line and supplying a precharge selection signal and an image signal supply selection signal. The selection switching element specifies a precharge period for precharging in response to the precharge selection signal, and specifies an image signal supply period in which an image signal having a predetermined display voltage is supplied to the corresponding data line in response to the image signal supply selection signal. Further, an image signal voltage is supplied to the selection switching element as a predetermined precharge voltage during a precharge period and as a predetermined display voltage during an image signal supply period (the precharge described herein is properly referred to as a “video precharge”).

Alternatively, with a selection switching element and a precharge selection switching element arranged on a data line, an image signal supply selection signal is supplied to the selection switching element and a precharge selection signal is supplied to the precharge selection switching element. The precharge selection switching element selects a precharge period in response to the precharge selection signal, and the selection switching element specifies an image signal supply period in response to the image signal supply selection signal.

Further, during the precharge period the precharge signal having a predetermined precharge voltage is supplied to the precharge selection switching element, and during the image signal supply period the image signal having a predetermined display voltage is supplied to the selection switching element (the precharge described herein is properly referred to as “common precharge” or simply “precharge”).

Scanning signals are provided to each scanning line to sequentially drive lines. In addition, after the image signal supply period elapses, the polarities of the image signal and the precharge signal are inverted, and at the same time, the supply of the scanning signal to the scanning signal ends, so that the selection of the scanning signal ends.

However, for the liquid crystal display as described above, even when the supply of the scanning signal ends, a timing when the selection of the scanning line ends at the pixel unit located around the center of the display screen might be later than a timing of polarity inversion of the image signal or the precharge signal due to a wiring resistance or a wiring capacitance. As such, an AC component of the image signal or the precharge signal is written to the data line through capacitance coupling with the selection switching element or the precharge selection switching element, and then, to the liquid crystal element through the data line, which may lead to malfunction of the liquid crystal element. As a result, when malfunction occurs with the liquid crystal device in a non-selected pixel unit, there is a problem in that quality of the display image is degraded.

### SUMMARY

An advantage of the present invention is that it provides an electro-optical device, such as a liquid crystal device capable of performing a high quality image display, by preventing malfunction of a display element, and various electronic apparatuses having the electro-optical device.

An electro-optical device according to a first aspect of the invention includes: a plurality of scanning lines; a plurality of data lines; a plurality of pixel units that are electrically connected to the scanning lines and the data lines, respectively, and have display elements, respectively; a plurality of selection switching elements that supply image signals to the data lines, in response to selection signals; a scanning line driving circuit that supplies scanning signals for line-sequentially selecting the plurality of scanning lines to the plurality of scanning lines, respectively; a selection signal supply circuit that, for one scanning line to which the scanning signal is supplied relatively earlier and another scanning line to which the scanning line is supplied relatively later among the plurality of scanning lines, supplies the selection signal to each of the selection switching elements after the supply of the scanning signal to the one scanning line ends and another scanning line is selected by the supply of the scanning signal; and an image signal supply circuit that supplies the image signal to each of the selection switching elements, wherein a period in which the voltage polarity of the image signal is inverted into either a first polarity or a second polarity with respect to a predetermined reference potential corresponds to a time until another scanning line is selected and the supply of the selection signal starts, after the supply of the scanning signal to the one scanning line ends.

In the electro-optical device according to the first aspect of the invention, each pixel unit includes a display element such as a liquid crystal device. In addition, as a driving device that drives the display element, a pixel switching element, such as a thin layer transistor (TFT), is arranged. Each scanning line extends along, for example, one direction in the image display region on a substrate.

When driving the first electro-optical device of the invention, each scanning line is line-sequentially selected based on the scanning signal supplied from the scanning line driving circuit. Here, ‘line-sequentially’ described herein refers to a case where each scanning line is selected one after another in one direction described above as well as a case where each scanning line is selected alternately in a plurality of parts of regions. In addition, by supplying the scanning signal from the selected scanning line, the corresponding pixel unit is selected. For example, by supplying the scanning signal from the selected scanning line to cause the pixel switching element to turn on, the pixel unit is selected.

Among the plurality of scanning lines, for a first scanning line to which the scanning signal is supplied relatively earlier and another scanning line to which the scanning signal is supplied relatively later, the selection signal is supplied to each selection switching element from the selection signal supply circuit after the supply of the scanning signal to the first scanning line ends and another scanning line is selected by supplying the scanning signal.

Further, the image signal is supplied to each selection switching element from the image signal supply circuit. More specifically, the image signal supply circuit inverts the voltage polarity of the image signal and adjusts the corresponding voltage to a predetermined value during a period until another scanning line is selected to start supplying the selection signal by the selection signal supply circuit after the supply of the scanning signal to the first scanning signal ends.

Each of the selection switching elements is turned on in response to the selection signal, and supplies the image signal to the data line. In other words, a period in which the image signal is supplied to the data line is determined by the selection switching element.

As a result, in the pixel unit selected by the scanning signal, the display element to which the image signal is supplied from the corresponding data line is AC driven by the supplied image signal to perform image display. At this time, the image signal supply circuit inverts the voltage polarity of the image signal after the selection of the first scanning line ends, so that the selection of the pixel unit corresponding to the first scanning line ends. Therefore, it can be prevented that, in the pixel unit corresponding to the first scanning line, the AC component of the image signal supplied through a capacitance coupling is written to the corresponding data line. Thus, for example, even for the pixel unit located around the center of the display screen, the voltage polarity of the image signal is inverted after the selection of the scanning line corresponding to the pixel unit ends, so that the AC writing of the image signal into the display element is prevented and malfunction of the display element can be prevented. As such, in the first electro-optical device of the invention, when the liquid crystal device, for example, is used as a display element, degradation of liquid crystal due to application of the DC component can be prevented. As a result, for each pixel unit, high quality image display can be performed.

In the electro-optical device according to the first aspect of the invention, the selection signal supply circuit supplies, as the selection signal, to the plurality of selection switching elements a batch of precharge selection signals that specify a precharge period during a period when another scanning line is selected, supplies, as the selection signal, to the selection switching element corresponding to one or more of simultaneously driven data lines image signal supply selection signals that specify an image signal supply period of one or the plurality of simultaneously driven data lines among the plurality of data lines, after the precharge period elapses, and wherein the image signal supply circuit inverts the voltage polarity of the image signal until the start of the precharge period after another scanning line is selected, while supplying the image signal as a precharge signal having a predetermined precharge potential during the precharge period and as an image signal having a display potential adjusted for each of the data lines during the image signal supply period.

According to this aspect, for a first scanning line to which the scanning signal is supplied relatively earlier and another scanning line to which the scanning signal is supplied relatively later among the plurality of scanning lines, the selection signal supply circuit supplies the precharge selection signal and the image signal supply selection signal as selection signals during a period that the selection of the first scanning line ends and another scanning line is being selected.

While the precharge selection signal is supplied, the plurality of selection switching elements turn on in a lump sum to specify the precharge period. The image signal supply circuit inverts the voltage polarity of the image signal until the start of the precharge period after another scanning line is selected. In addition, during the precharge period, the image signal is supplied from the image signal supply circuit as a precharge signal. Further, image signals are supplied to the plurality of data lines by the plurality of selection switching elements, so that the precharge of the data lines can be performed by video precharge.

Therefore, even when the video precharge is performed, for the pixel unit corresponding to the first scanning line where the supply of the scanning signal ends, it can be prevented that an AC component of the image signal is written to the display element.

After the precharge period elapses, the image signal supply selection signal is supplied, and the selection switching element corresponding to one or more data lines of a plurality of data lines turn on, so that an image signal supply period is specified. The image signal supply circuit supplies the image signal during the image signal supply period as a voltage having the display potential adjusted for the data line. In other words, in the image signal supply period, the ‘image signal’ in a limited sense, having the original or adjusted voltage as described is supplied from the image signal supply circuit. In addition, the image signal is supplied to the data line through the selection switching element that is turned on. Thereby, the first data line is driven, or alternatively, a plurality of data lines corresponding to the selection switching element turned on are simultaneously driven. Further, the image signal from the driven data line is supplied for the selected pixel unit to perform image display.

Here, the precharge signal is written during the precharge period, and thus, the plurality of data lines are precharged. Therefore, the writing of the image signal into the data line during the image signal supply period can be performed in a relatively short time.

The electro-optical device according to the first aspect of the invention may further include: a plurality of precharge selection switching elements that supply a batch of precharge signals to the plurality of data lines in response to a precharge selection signal that specifies the precharge period; and a precharge signal supply circuit that supplies to each of the precharge selection switching elements the precharge signal at least during the precharge period by inverting a voltage of the precharge signal into either the first polarity or the second polarity corresponding to the voltage polarity of the image signal until the start of the precharge period after another scanning line is selected, wherein the selection signal supply circuit supplies to the plurality of precharge selection switching elements a batch of the precharge selection signal during a period that another scanning line is selected, supplies, as the selection signal, to the selection switching element corresponding to one or more of simultaneously driven data lines image signal supply selection signals that specify an image signal supply period of one or the plurality of simultaneously driven data lines among the plurality of data lines, after the precharge period elapses, and inverts the voltage polarity of the image signal until the start of the precharge period after another scanning line is selected, while supplying the image signal as a precharge signal having a predetermined precharge potential during the precharge period and as an image signal having a display potential adjusted for each of the data lines during the image signal supply period.

According to this aspect, for a first scanning line to which the scanning signal is supplied relatively earlier and another scanning line to which the scanning signal is supplied relatively later among the plurality of scanning lines, the selection signal supply circuit supplies the precharge selection signal and the image signal supply selection signal as selection signals during a period that the selection of the first scanning line ends and another scanning line is selected.

While the precharge selection signal is supplied, the plurality of selection switching elements turn on in a lump sum to specify the precharge period. The precharge signal supply circuit inverts the voltage polarity of the precharge signal until the start of the precharge period after another scanning line is selected, corresponding to the voltage polarity of the image signal supplied to the data line during the image signal supply period. In addition, at least during the precharge period, the precharge signal supply circuit supplies the precharge signal. In addition, the image signal supply circuit inverts the voltage polarity of the image signal until the start of the precharge period after another scanning line is selected. Under these circumstances, the precharge of the data lines can be performed by a common precharge.

Further, during the precharge period, the precharge signals are supplied to the plurality of data lines in a lump sum through the plurality of precharge selection switching elements, precharge signals are supplied to the plurality of data lines in a lump sum. In addition, under a state that the selection of the pixel unit corresponding to the first scanning line ends, the voltage polarity of the precharge signal can be inverted by the precharge signal supply circuit, and thus, the voltage polarity of the image signal is inverted by the image signal supply circuit. Therefore, it can be prevented that the AC component of the precharge signal or the image signal supplied through the capacitance coupling of the precharge selection switching element or the selection switching element is written to the corresponding data line.

After the precharge period elapses, the image signal supply selection signal is supplied for the selection switching element corresponding to one or more data lines of the plurality of data lines and the image signal supply period is specified. The image signal supply circuit supplies the image signal in the original or limited sense during the image signal supply period. In addition, the image signal from the data line is supplied for the selected pixel unit to perform image display. Here, since the data line is precharged, the writing of the image signal into the data line can be performed in a relatively short time during the image signal supply period.

In addition, when the common precharge as described above is performed, the precharge signal supply circuit may invert the voltage polarity of the precharge signal after the start of the precharge period and around the start of the precharge period, and at the same time, invert the voltage polarity of the image signal. Accordingly, a retrace time can be shortened.

An electro-optical device according to a second aspect of the invention includes: a plurality of scanning lines; a plurality of data lines; a plurality of pixel units that are electrically connected to the scanning lines and the data lines, respectively, and have display elements, respectively; a plurality of selection switching elements that supply image signals for the data lines, in response to selection signals; a scanning line driving circuit that supplies scanning signals for line-sequentially selecting the plurality of scanning lines to the plurality of scanning lines, respectively; a selection signal supply circuit that, for one scanning line to which the scanning signal is supplied relatively earlier and another scanning line to which the scanning line is supplied relatively later among the plurality of scanning lines, supplies, as the selection signal, to the plurality of selection switching elements a batch of precharge selection signals that specify a precharge period during a period that the supply of the scanning signal to the first scanning line ends and another scanning signal is selected by the supply of the scanning signal, while supplying, as the selection signal, to the selection switching element corresponding to one or more of simultaneously driven data lines image signal supply selection signals that specify an image signal supply period of the one or more of simultaneously driven data lines among the plurality of data lines, after the precharge period elapses; and an image signal supply circuit that inverts voltage polarity of the image signal into either a first polarity or a second polarity with respect to a predetermined reference potential at the start of the precharge period while supplying the image signal to each of the selection switching elements as a precharge signal having a predetermined precharge potential during the precharge period and as an image signal having a display potential adjusted for each of the data lines during the image signal supply period.

In the electro-optical device according to the second aspect of the invention, a plurality of data lines are precharged in a lump sum during a precharge period and this precharge can be performed by video precharge, as in the first electro-optical device of the invention described above.

In addition, under the state that the selection of the pixel unit corresponding to the first scanning line ends, the image signal supply circuit inverts the voltage polarity of the image signal. Therefore, in the pixel unit corresponding to the first scanning line, it can be prevented that the AC component of the image signal supplied through the capacitance coupling of the selection switching element is written to the corresponding data line. Thus, for example, even for the pixel unit located around the center of the display screen, malfunction of the display element can be prevented. As a result, high quality image display can be performed for each pixel unit.

Further, with respect to the polarity inversion by the image signal supply circuit, the voltage of the image signal is adjusted to a predetermined precharge voltage, so that a variation of the voltage of the image signal accompanied by the polarity inversion can be made relatively little. In addition, timing for inverting the voltage polarity of the image signal may be around the start of the precharge period. In this case, when the timing is set to be before the start of the precharge period, the benefit that the voltage variation of the image signal described above is made little is not obtained. Thus, it is preferably that the timing is set to be after the start of the precharge period. As such, the timing for inverting the voltage polarity of the image signal is set to be after the start of the precharge period and around the start of the precharge period, a retrace time can be shortened.

Further, after the precharge period elapses, the writing of the image signal into the data line can be performed in a relative short time during the image signal supply period.

In the electro-optical device according to the first or second aspect of the invention, each of the pixel units may include a pixel switching element that switch-controls each of the display elements, the display elements are provided in opposite to pixel electrodes, with an electro-optical material interposed between counter electrodes serving as common potentials, the pixel switching element supplies to the pixel electrode the image signal supplied from the data line in response to the scanning signal supplied from the scanning line, and the display element performs image display based on the image signal.

According to this aspect, the display element in each pixel unit is switch-controlled by a pixel switching element. More specifically, the pixel switching element supplies for the pixel electrode of the display element the image signal supplied from the corresponding data line, in response to the scanning signal supplied from the corresponding scanning line. Thereby, it is possible to drive each pixel unit in a form of active matrix.

In addition, for each pixel unit, the display element has electro-optical material such as liquid crystal interposed between the pixel electrode and the counter electrode. Further, the voltage specified by the respective potentials of the pixel electrode and the counter electrode is applied to the electro-optical material to perform image display with the display element. Here, for each pixel unit, the counter electrode of the display element maintains a common predetermined potential. In addition, the image signal having an inverted polarity is supplied to the pixel electrode so that the display element can be AC driven.

An electronic apparatus of the invention includes the electro-optical device according to the first or second aspect of the invention described above.

The electronic apparatus of the invention includes the first or second electro-optical device of the invention described above, so that there can be implemented various electronic apparatuses such as projection type display elements, televisions, mobile phones, electronic notepads, word processors, view finder type or monitor direct view type video tape recorders, workstations, television phones, POS terminals, and touch panels, with which high quality image display can be performed. In addition, as an electronic apparatus of the invention, an electrophoresis apparatus such as an electronic paper, an electron emission apparatus (field emission display and conduction electron-emitter display), and a digital light processing (DLP) that uses the electrophoresis apparatus and the electron emission apparatus can be can be implemented.

### BRIEF DESCRIPTION OF THE DRAWINGS

The invention will be described with reference to the accompanying drawings, wherein like numbers reference like elements, and wherein:

FIG. 1 is a plan view showing an overall arrangement of a liquid crystal panel;

FIG. 2 is a cross sectional view taken along a line H-H′ of FIG. 1;

FIG. 3 is a block diagram showing an overall arrangement of a liquid crystal device;

FIG. 4 is a block diagram showing an electrical arrangement of a liquid crystal panel;

FIG. 5 is a timing chart showing a temporal change of various signals based on operation of the liquid crystal device;

FIG. 6 is a timing chart showing a temporal change of various signals based on a modified example;

FIG. 7 is a block diagram showing an overall arrangement of a liquid crystal device according to the second embodiment of the invention;

FIG. 8 is a block diagram showing an electrical arrangement of a liquid crystal panel according to the second embodiment of the invention;

FIG. 9 is a timing chart showing a temporal change of various signals based on operation of the liquid crystal device according to the second embodiment of the invention;

FIG. 10 is a plan view showing an arrangement of a projector, which is an example of an electronic apparatus to which the liquid crystal device is applied;

FIG. 11 is a perspective view showing an arrangement of a personal computer, which is an example of an electronic apparatus to which the liquid crystal device is applied; and

FIG. 12 is a perspective view showing an arrangement of a mobile phone, which is an electronic apparatus to which the liquid crystal device is applied.

### DETAILED DESCRIPTION OF EMBODIMENTS

Exemplary embodiments of the invention will now be described with reference to the accompanying drawings. In the following embodiments, electro-optical devices of the invention are applied to a liquid crystal device.

### 1: First Embodiment

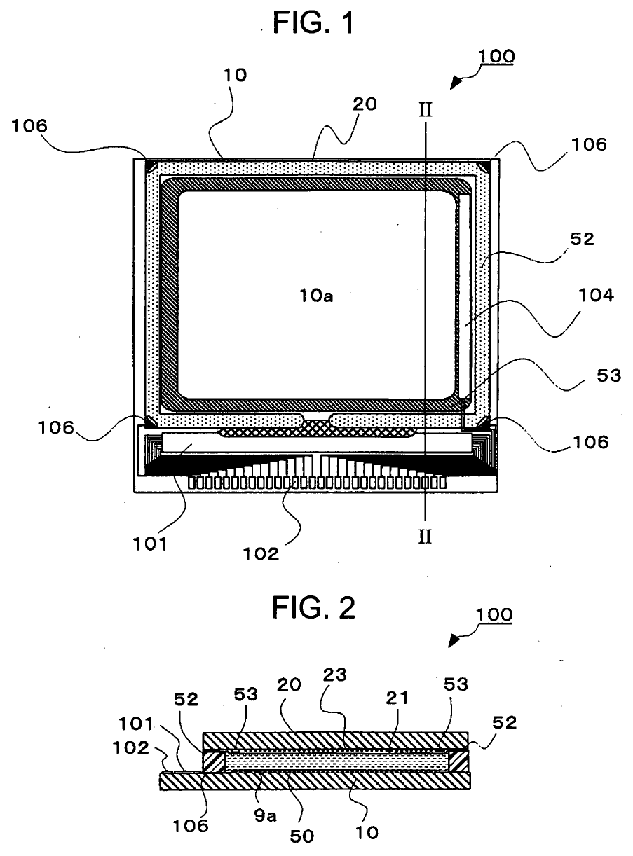

First, an electro-optical device according to the first embodiment of the invention will be described with reference to FIGS. 1 to 5.

1-1: Overall Arrangement of an Electro-Optical Panel

For a liquid crystal device as an example of an electro-optical device of the invention, an overall arrangement of a liquid crystal panel as an example of an electro-optical panel will be described with reference to FIGS. 1 and 2. Here, FIG. 1 is a schematic plan view of the liquid crystal panel according to the invention, showing a TFT array substrate along with each component formed thereon seen from an counter substrate, and FIG. 2 is a cross sectional view taken along a line H-H′ of FIG. 1. Here, a liquid crystal device having a driving circuit embedded type TFT active matrix drive scheme will be illustrated.

In FIGS. 1 and 2, a TFT array substrate 10 and a counter substrate 20 are arranged to face each other in a liquid crystal panel 100 according to the present embodiment. A liquid crystal layer 50 is encapsulated between the TFT array substrate 10 and the counter substrate 20 so that the TFT array substrate 10 and the counter substrate 20 are attached to each other with sealant 52 arranged at a sealing area located around an image display region 10a.

The sealant 52 is made of, for example, ultraviolet curing resin, and thermosetting resin, etc., for attaching both substrates, and deposited on the TFT array substrate 10 during a manufacturing process, and cured by UV violet and heating. In addition, of the sealant 52, gap material such as glass fiber or glass bead for maintaining a predetermined gap between the TFT array substrate 10 and the counter substrate 20 is applied.

A shading type liquid crystal light blocking layer 53 that specifies the liquid crystal region of the image display region 10a along with a place inside the sealing area where the sealant 52 is arranged is arranged on the side of the counter substrate 20. However, a portion or all of the liquid crystal light blocking layer 53 may be arranged as an embedded light blocking area on the side of the TFT array substrate 10.

Among the peripheral region located around the image display region 10a, a data line driving circuit 101 and an external circuit connection terminal 102 are arranged along one side in an area located outside the sealing region where the sealant 52 is arranged. In addition, the scanning line driving circuit 104 may be arranged along two sides adjacent to this one side such that it is covered with the liquid crystal light blocking layer 53. In addition, the scanning line driving circuit 104 may be arranged along two sides adjacent to one side of the TFT array substrate 10 where the data line driving circuit 101 and the external circuit connection terminal 102 are arranged. In this case, two scanning line driving circuits 104 are connected to each other by a plurality of wirings arranged along the remaining one side of the TFT array substrate 10.

In addition, at four corners of the counter substrate 20, up and down conducting material acting as an up and down conducting terminal between two substrates is arranged. Further, for the TFT array substrate 10, the up and down conducting terminal is arranged on regions that faces these corners. With these, electric conduction between the TFT array substrate 10 and the counter substrate 20 can be achieved.

In FIG. 2, on the TFT array substrate 10, an alignment layer is formed on the pixel electrode 9a after TFTs for pixel switching, and wirings such as scanning lines and data lines are formed. Further, on the counter substrate 20, a trellis type or a stripe type light blocking layer 23 in addition to the counter electrode 21, and moreover, an alignment layer at the utmost portion are formed. In addition, the liquid crystal layer 50 is made of, for example, liquid crystal combined with one or various types of nematic liquid crystal, and is arranged in a predetermined alignment state between a pair of alignment layers.

In addition, although not shown in FIGS. 1 and 2, a sampling circuit is formed on the TFT array substrate 10 for sampling and supplying image signals on the image signal lines for the data lines as described below, in addition to the data line driving circuit 101 and the scanning line driving circuit 104. According to the present embodiment, an inspection circuit for inspecting quality and defect of the given electro-optical device under manufacturing or before shipment may be arranged.

1-2: Overall Arrangement of Electro-Optical Device

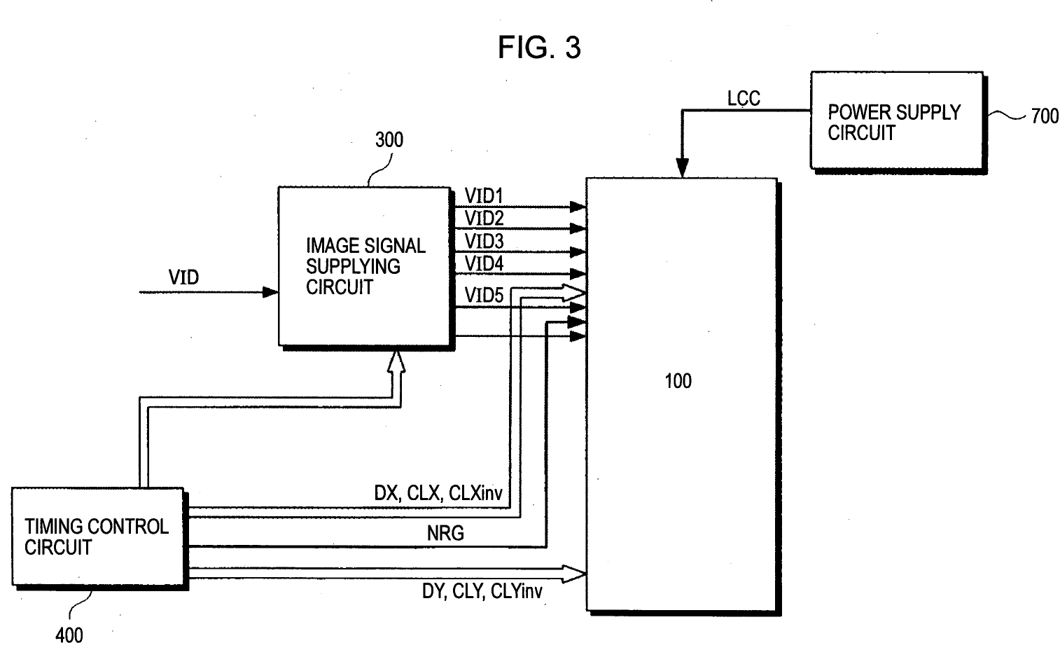

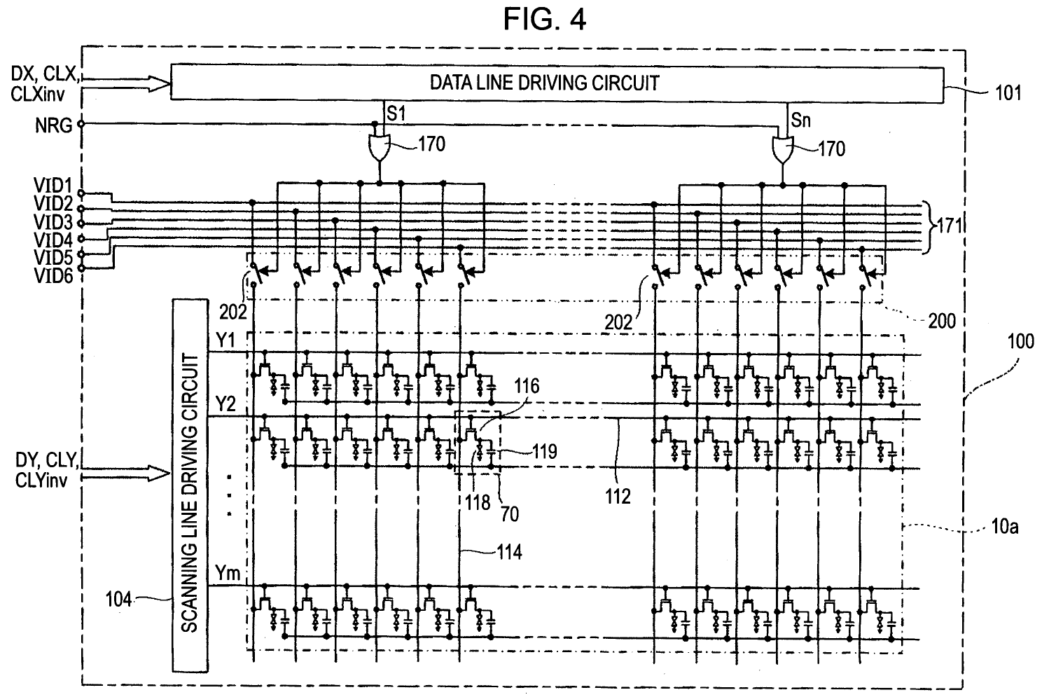

An overall arrangement of the liquid crystal device will be described with reference to FIGS. 3 and 4. Here, FIG. 3 is a block diagram showing an overall arrangement of the liquid crystal device, and FIG. 4 is a block diagram showing an electrical arrangement of a liquid crystal panel.

As shown in FIG. 3, the liquid crystal device largely has a liquid crystal panel 100, an image signal supply circuit 300, a timing control circuit 400, and a power supply circuit 700.

The timing control circuit 400 is configured to output various timing signals for use in various units. In the present embodiment, a ‘selection signal supply circuit’ according to the invention largely has the timing control circuit 400 and the data line driving circuit 101. A timing signal output unit as a portion of the timing control circuit 400 makes a dot clock, a minimal unit of a clock for scanning each pixel, and based on the dot clock, a Y clock signal CLY, an inverted Y clock signal CLYinv, an X clock signal CLX, an inverted X clock signal XCLinv, a Y start pulse DY and an X start pulse DX are generated. In addition, the timing control circuit 400 generates a precharge selection signal NRG that specifies the precharge period.

In the image signal supply circuit 300, a series of input image data VID are input from the external. The image signal supply circuit 300 serial-parallel converts a series of input image data VID to generate N phase (in the present embodiment, 6 phase, i.e., N=6) image signals VID1 to VID6. Further, the image signal supply circuit 300 outputs the image signals VID 1 to VID6 by converting each voltage of image signals VID 1 to VID6 into the ‘first polarity’ and the ‘second polarity’ with respect to a predetermined reference potential v0.

In addition, the power supply circuit 700 supplies a common power supply of a predetermined common voltage LCC for the counter electrode shown in FIG. 2. In the present embodiment, the counter electrode 21 is formed to face with a plurality of pixel electrodes 9a below the counter substrate 20 shown in FIG. 2.

Next, an electrical arrangement of the liquid crystal panel 100 is described.

On the liquid crystal panel 100 as shown in FIG. 4, an internal driving circuit including the scanning line driving circuit 104, the data line driving circuit 101, and a sampling circuit 200 is arranged around the peripheral area of the TFT array substrate 10.

The Y clock signal CLY, the inverted Y clock signal CLYinv, and the Y start pulse DY are supplied for the scanning line driving circuit 104. When the Y start pulse DY is input, the scanning line driving circuit 104 generates scanning line signals Y1, . . . , Ym, at a timing based on the Y clock signal CLY and the inverted Y clock signal CLYinv.

The X clock signal CLX, the inverted X clock signal CLXinv, and the X start pulse DX are supplied for the data line driving circuit 101. When the X start pulse DX is input, the data line driving circuit 101 generates sampling signals S1, . . . , Sn as ‘image signal supply selection signals’ according to the invention at a timing based on the X clock signal CLX and the inverted X clock signal XCLinv.

The sampling circuit 200 is a ‘selection switching element’ according to the invention, having a plurality of sampling switches 202 that include one channel type TFTs such as P channel TFTs and N channel TFTs or complementary TFTs.

Further, the liquid crystal panel 100 has data lines 114 and scanning lines 112 arranged in rows and columns in the image display region 10a that occupies a center of the TFT array substrate, and has a TFT 116 for switch-controlling the pixel electrode 9a of the liquid crystal device 118 arranged in a matrix the pixel electrode 9a as an ‘pixel switching element’ according to the invention, in each pixel unit 70 corresponding to intersections between the data lines 114 and the scanning lines 112. In addition, according to the invention, assume that in particular the total number of scanning lines 112 is m (where, m is a natural number not less than 2) and the total number of data lines 114 is n (where, n is a natural number not less than 2).

The 6 phase serial-parallel expanded image signals VID1 to VID 6 are supplied to the liquid crystal panel 100 through the image signal lines 171, respectively. In addition, as shown in FIG. 4, N sampling switches 202 (where N is 6 in the present embodiment) are gathered in one group for the sampling circuit 200, and an OR circuit 170 is arranged corresponding to the sampling switches 202 that belong to one group. In addition, the precharge selection signal NRG generated by the timing control circuit 400 is input to the sampling switches 202 that belong to one group through the OR circuit 170, while the sampling signals Si (i=1, 2, . . . , n) are input from the data line driving circuit 101. The sampling switches 202 that belong to one group makes N data lines (where N is 6 in the present embodiment) 114 one group, and for the data lines 114 belonging to one group, the 6 phase serial-parallel expanded image signals VID1 to VID 6 are sampled and supplied in response to the precharge selection signal NRG or the sampling signal Si. In other words, 6 image signal lines 171 are electrically connected to the data lines 114 that belong to one group through the sampling switches 202 that belong to one group. Therefore, according to the invention, to drive the n data lines 114 for each data line 114 belonging to one group, a drive frequency is suppressed.

In FIG. 4, with respect to an arrangement of one pixel unit 70, the data line 114 to which the image signal VIDk (here, k=1, 2, 3, . . . , 6) is electrically connected to a source electrode of the TFT 116 while the scanning line 112 to which the scanning signal Yj (here, j=1, 2, 3, . . . , m) is electrically connected to a gate electrode of the TFT 1 16 and the pixel electrode 9a of the liquid crystal device 118 is connected to a drain electrode of the TFT 116. Here, for each pixel unit 70, the liquid crystal device 119 has liquid crystal interposed between the pixel electrode 9a and the counter electrode 21. Therefore, each pixel unit 70 is arranged in a matrix corresponding to each intersection between the scanning line 112 and the data line 114.

Each scanning 112 is line-sequentially selected by scanning signals Y1, . . . , Ym output from the scanning line driving circuit 104. For the pixel unit 70 corresponding to the selected scanning line 112, when the scanning signal Yj is supplied for the TFT 116, the TFT 116 turns on so that the given pixel unit 70 becomes a selected state. For the pixel electrode 9a of the liquid crystal device 118, the image signal VIDk is supplied from the data line 114 at a predetermined timing by closing the switch of the TFT 116 for a certain time. With this, an application voltage specified by each potential of the pixel electrode 9a and the counter electrode 21 is applied to the liquid crystal element 118. Alignment or ordering of a molecular group is changed with the applied voltage level, thereby modulating light to enable gray scale level display. If a normally white mode, transmittance of incident light is reduced in response to the voltage applied to each pixel unit, and if a normally black mode, transmittance of incident light is increased in response to the voltage applied to each pixel unit. Thus, generally, light having a contrast in response to the image signals VID1 to VID6 exit from the liquid crystal panel 100.

Here, in order to prevent the retained image signal from leaking, a storage capacitor 119 is added in parallel to the liquid crystal device 118. For example, the voltage of the pixel electrode 9a is retained in the storage capacitor 119 for a time 3 digits longer than one for which the source voltage is applied, so that a retention characteristic is improved, leading to implementation of high contrast.

1-3: Operation of Electro-Optical Device

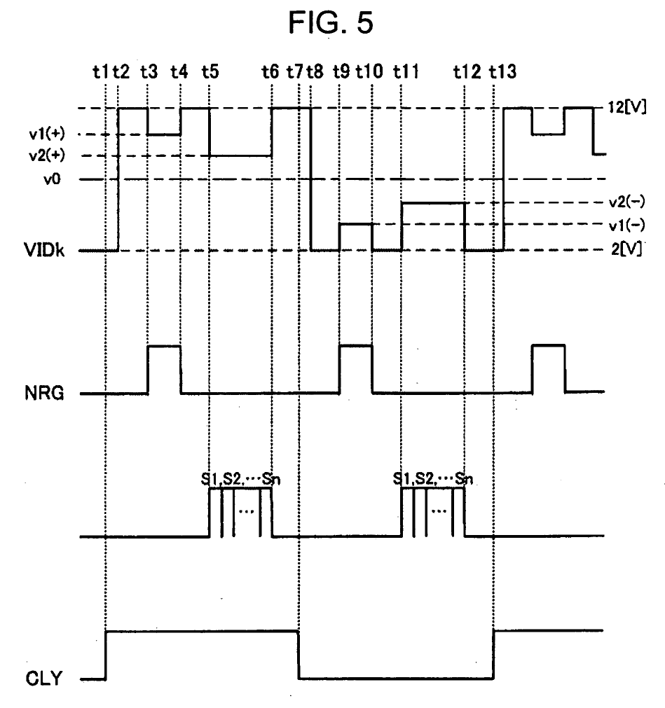

Next, in addition to FIGS. 1 to 4, operation of the liquid crystal device is described with reference to FIG. 5. FIG. 5 is a timing chart showing a temporal change of various signals based on operation of the liquid crystal device.

A plurality of scanning lines 112 are arranged in a vertical direction in the image display region 10a of FIG. 4. According to the invention, a plurality of scanning lines 112 are selected one after another based on the arrangement and direction in FIG. 4. In the following explanation, the pixel unit 70 corresponding to the scanning line 112 (j-1)th and jth selected is focused.

In addition, according to the present embodiment, for each pixel unit 70, the liquid crystal device 118 performs a normally white mode of display. Further, in FIG. 5, the display potential of the image signal VIDk for displaying a black color with the liquid crystal device 118 is a positive polarity of 12V and a negative polarity of 2V.

Here, a selection period of each scanning line 112 corresponds to a period in which the scanning signal Yi is output from the scanning line driving circuit 104. Further, the selection period of each scanning line 112 is specified with the Y clock signal CLY and the inverted Y clock signal CLYinv. In FIG. 5, when the Y clock signal CLY arises from a low level to a high level for a timing t1, the scanning signal Yj-1 is supplied from the scanning line driving circuit 104, so that the (j-1)th scanning line 112 is selected. The (j-1)th scanning line 112 becomes a selection state during a period from the time t1 to t7 when the Y clock signal CLY is in the high level, and the pixel unit 70 corresponding to the (j-1)th scanning line 112 is selected.

After the (j-1)th scanning line 112 is selected, the timing control circuit 400 supplies the precharge selection signal NRG at the timing t3. In addition, for a period from the time t1 to the time t3, the image signal supply circuit 300 inverts the voltage polarity of the image signal VIDk from the negative polarity to the positive polarity at the timing t2. Along with the polarity inversion, the potential of the image signal VIDk of 2V is changed into the potential of 12V with a center of the reference potential v0.

The precharge selection signal NRG is supplied to n sampling switches 202 of the sampling circuit 200 through the OR circuit 170 in a lump sum. Further, during a period from the time t3 to the time t4 in which the precharge selection signal NRG is supplied, n sampling switches 202 turn on in a lump sum so that a precharge period is selected.

The image signal supply circuit 300 adjusts the precharge voltage specified by a predetermined reference potential v0 and a precharge potential v1(+) during a precharge period. Further, the image signal VIDk having a precharge voltage is supplied to the n sampling switches 202 from the image signal supply circuit 300 as a precharge signal. Each sampling switch 202 supplies the precharge signal to the corresponding data line 114. With this, n data lines 114 are precharged in a lump sum.

At the timing t4, when the supply of the precharge selection signal NRG ends so that the precharge period ends, the image signal supply circuit 300 adjusts the image signal VIDk from the precharge voltage v1(+1) to the voltage of 12V. As such, with the adjusted image signal VIDk, the supply of the precharge signal ends.

Next, at the timing t5, the sampling signal Si is supplied from the data line driving circuit 101 and supplied for the sampling switches 202 of the sampling circuit 200 through the OR circuit 170. In addition, during a period from the time t5 to the time t6 in which the sampling signal Si is supplied, the sampling switches 202 turn on one after another in response to the output of the sampling signal Si, which is an output of a shift register. At this time, since the parallel-serial expansion is employed, the sampling switches 202 connected to the same sampling signal Si are assumed to turn on in a lump sum. According to the present embodiment, in particular, during a period of one consecutive image signal supply period (e.g., during a period of t5 to t6 in FIG. 5), the sampling signals S1, . . . , Sn are output in response to the image signal VIDk by one line. In addition, during a period of another consecutive image signal supply period (for example, during a period of t11 to t12 in FIG. 5), the sampling signals S1, . . . , Sn are output in response to the image signal VIDk by another line. At any rate, the sampling of the image signal is performed only during the image signal supply period, so that the supply of the image signal VIDk to the data line 114 is performed.

The image signal supply circuit 300 adjusts the voltage of the image signal VIDk into a display voltage specified by a predetermined reference potential v0 and a display potential of v2(+) during a period from t5 to t6. Further, the image signal VIDk of the display voltage is supplied for the corresponding data line 114 from the image signal supply circuit 300 through the sampling switch 202 turned on. Each image signal VIDk is supplied for the pixel unit corresponding to the data line 114 driven as described above and further corresponding to (j-1)th scanning line 112. As such, during a period from the time t5 to t6, the image signal VIDk corresponding to the image data to be actually displayed is supplied through the sampling switch 202 and the data line 114.

At the timing t6, when the supply of the sampling signal Si ends so that the image signal supply period ends, the image signal supply circuit 300 adjust the image signal VIDk from the display potential v2(+) to the potential of 12V. Next, at the timing t7, the selection of the pixel unit 70 corresponding to the (j-1)th scanning line 112 ends.

Subsequently, when the Y clock signal CLY si lowered from the high level to the low level at the timing t7, the scanning signal Yj is supplied from the scanning line driving circuit 104 so that the jth scanning line 112 is selected. When the Y clock signal CLY is in the low level, the jth scanning line 112 becomes a selection state during a period from the time t7 to t13, so that the pixel unit 70 corresponding to the jth scanning line 112 is selected.

For the selection period of the jth scanning line 112, the precharge selection signal NRG is supplied from the timing control circuit 400 during a period from the time t7 to t10, and then, the sampling signal Si is supplied from the data line driving circuit 101 during a period from the time t11 to t12, as in the selection period of the (j-1)th scanning line 112. With this, n data lines 114 are precharged in a lump sum during the precharge period, and then, the image display corresponding to each drive data line 114 and further corresponding to the jth scanning line 112 is performed during the image signal supply period.

Here, the image signal supply circuit 300 inverts the voltage polarity of the image signal VIDk from the positive polarity to the negative polarity at the timing t8, for a period after the time t7 and before the time t9. Along with the polarity inversion, the potential of the image signal VIDk of 12V is changed into the potential of 2V with a center of the reference potential v0. Further, the image signal supply circuit 300 adjusts the voltage of the image signal VIDk into the precharge voltage specified by the predetermined reference potential v0 and the precharge potential v1(−) to supply the image signal VIDk as a precharge signal. In addition, the image signal supply circuit 300 adjusts the image signal VIDk into a display voltage specified by the predetermined reference potential v) and the display potential v2(−) during the image signal supply period and supplies it to each data line.

As described above, for each pixel unit 70, the liquid crystal device 118 are supplied and AC driven with the image signal VIDk having an inverted voltage polarity. For the (j-1)th and the jth selected scanning lines 112, the image signal supply circuit 300 inverts the voltage polarity of the image signal VIDk after the selection of the (j-1)th scanning line 112 ends. Therefore, the selection of the pixel unit 70 corresponding to the (j-1)th scanning line 112 ends, so that it can be prevented that the AC component of the image signal VIDk supplied through a capacitive coupling of the sampling switch 202 into the corresponding data line 114 is written. Therefore, for example, for the pixel unit 70 located around the center of the display screen, the selection of the scanning line 112 corresponding to the give pixel unit 70 ends so that the voltage polarity of the image signal VIDk is inverted. Therefore, the writing of the AC component of the image signal VIDk into the liquid crystal device 118 is prevented and malfunction of the liquid crystal device 118 can be prevented. Thus, for the liquid crystal device 118, degradation of the liquid crystal device due to the application of the DC component can be prevented. As a result, high quality image display can be performed for each pixel unit 70.

Here, the precharge signal is written during the precharge period, and thus, the n data lines 114 are precharged. Therefore, compared with a case where the precharge is not performed, it is possible that a voltage variation of the data line 114 driven by the writing of the polarity inverted image signal VIDk is made relatively small. Thus, it is possible that the writing of the display voltage into each data line 114 is performed for a relative short time.

In addition, the embodiment described herein is not limited to a case where the n data lines 114 are driven for data lines 114 belonging to one group as described above, but may be driven for each data line 114. Alternatively, the n data lines 114 may be any of 3 types, i.e., red (R) color, green (G) color, and blue (B) color, respectively, and may be drive for data lines 114 belonging to one group, using three types of data lines such as R, G, and B. In the latter case, the image signal supply circuit 300 generates the image signal as a R signal, a G signal, and a B signal, corresponding to each of RGB color, based on the input image data VID.

1-4: Modification

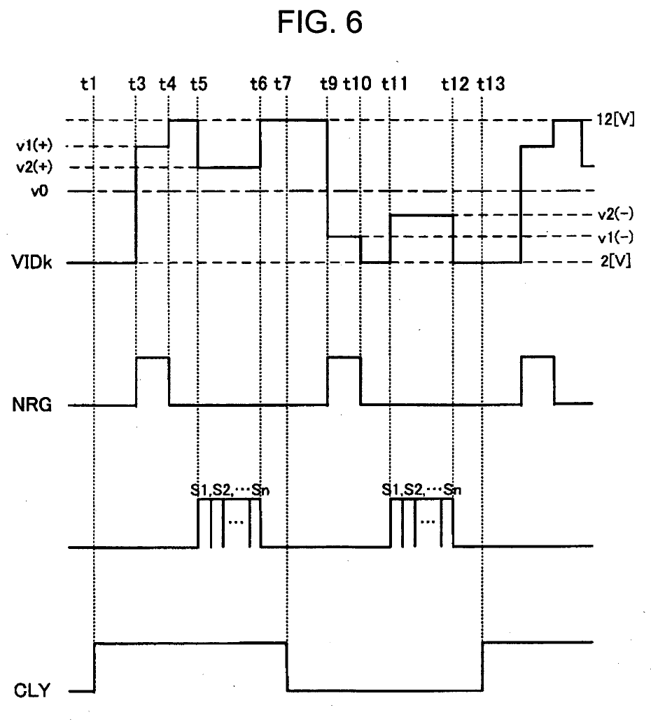

A modification of the first embodiment described above is described with reference to FIG. 6. FIG. 6 is a timing chart showing a temporal change of various signals according to the present modification.

In FIG. 6, for a selection period of the (j-1)th scanning line 112, the image signal supply circuit 300 inverts the voltage polarity of the image signal VIDk from the negative polarity to the positive polarity at the timing t3 of the start of the precharge period. In addition, for a selection period of the jth scanning line 112, the inversion of the voltage polarity of the image signal VIDk is performed at the timing t9 of the start of the precharge period.

In other words, for the (j-1)th and the jth selected scanning lines 112, the selection of the pixel unit 70 corresponding to the (j-1)th scanning line 112 ends, and then, the voltage polarity of the image signal VIDk is inverted. Therefore, it can be prevented that the AC component of the image signal VIDk supplied through a capacitive coupling between the sampling switch 202 and the corresponding data line 114 is written to the (j-1)th scanning line 112.

In addition, for the polarity inversion of the image signal supply circuit 300, the voltage of the image signal VIDk is not adjusted to a predetermined precharge voltage, so that it is possible to cause the voltage variation of the image signal VIDk accompanied by the polarity inversion to be relatively small.

In addition, for the selection period of the (j-1)th scanning line 112, a period from the time t2 to t5 of FIG. 5 and a period from the time t3 to t5 correspond to a retrace time. In addition, the retrace time for the selection period of the jth scanning line 112 corresponds to a period from the time t8 to t11 of FIG. 5 and a period from the time t9 to t11 of FIG. 6. In the present modification, a timing for inverting the voltage polarity of the image signal VIDk may be determined to be around the start of the precharge period. In this case, the voltage variation of the afore-mentioned image signal VIDk is not suppressed for a time before the start of the precharge period, so that it is desirable to perform this for a time after the start of the precharge period. As such, the timing for inverting the voltage polarity of the image signal VIDk is set to be after the start of the precharge period and around the start of the precharge period, so that the retrace time can be reduced. Alternatively, precharge can be performed within a short retrace time.

### 2: Second Embodiment

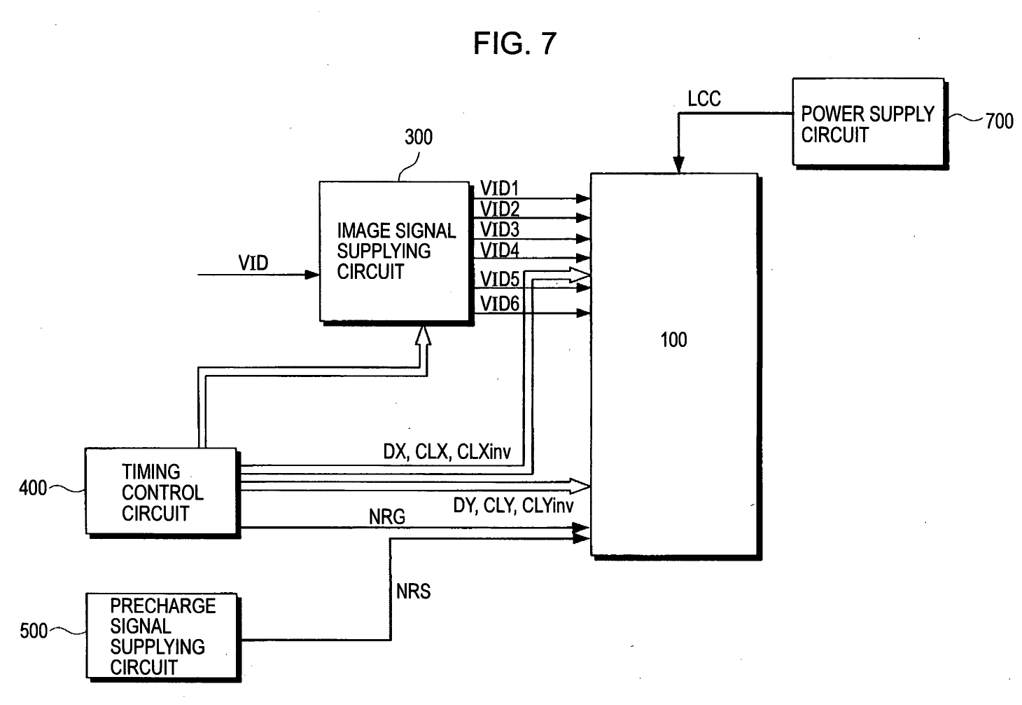

Next, an electro-optical device according to the second embodiment of the invention is described. In the second embodiment, the liquid crystal device as an electro-optical device is different from that of the first embodiment in terms of the arrangement of the internal driving circuit for the liquid crystal panel. Therefore, in the following explanation, arrangement and operation of the liquid crystal device different from those in the first embodiment will be described with reference to FIGS. 7 to 9. In addition, for the same arrangement with that of the first embodiment, like numbers refers to like elements, and thus, description thereof will be omitted.

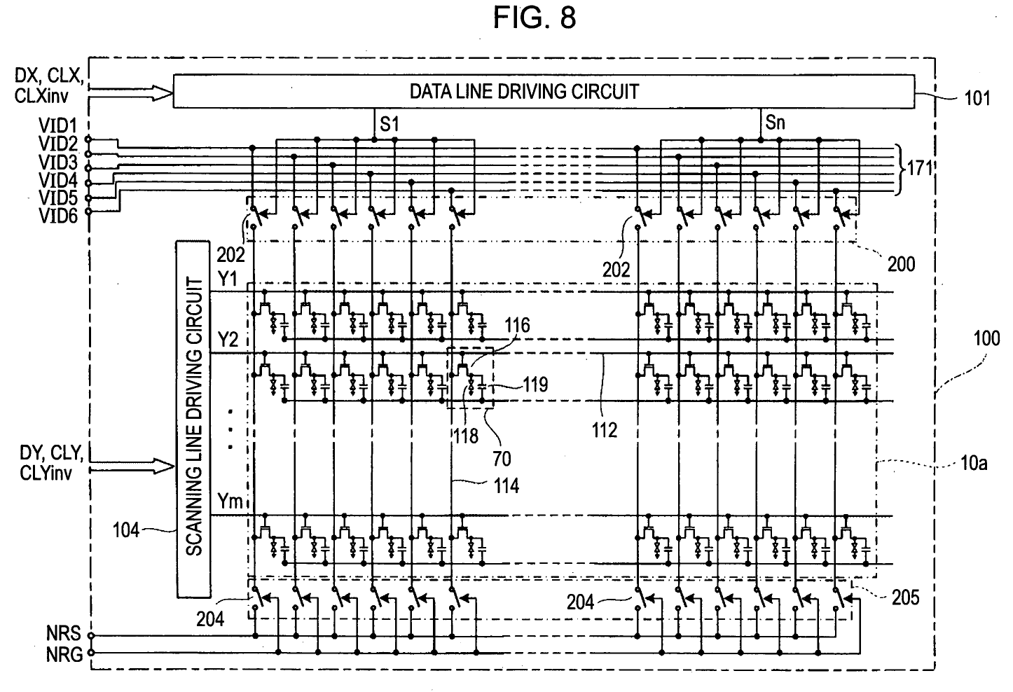

First, an overall arrangement of the liquid crystal device according to the second embodiment of the invention is described with reference to FIGS. 7 and 8. Here, FIG. 7 is a block diagram showing an overall arrangement of a liquid crystal device according to the second embodiment of the invention, and FIG. 8 is a block diagram showing an electrical arrangement of a liquid crystal panel according to the second embodiment of the invention.

In FIG. 7, the liquid crystal device largely includes a liquid crystal panel 100, an image signal supply circuit 300, a timing control circuit 400, and a power supply circuit 700 as well as a precharge signal supply circuit 500. The precharge signal supply circuit 500 inverts the voltage of the precharge signal NRS from the positive polarity to the negative polarity in response to the voltage polarity of the image signal VIDk supplied to the data line 114 during the image signal supply period, and supplies the precharge signal NRS. In other words, in the first embodiment, video precharge is performed, while in the second embodiment common precharge is performed.

Next, an electrical arrangement of the liquid crystal panel 100 of the liquid crystal device is described with reference to FIG. 8.

In FIG. 8, an internal driving circuit of the liquid crystal panel 100 includes a scanning line driving circuit 104, a data line driving circuit 101, and a sampling circuit 200 as well as a precharge circuit 205. The precharge circuit 205 is a ‘selection switching element’ according to the invention, having a plurality of sampling switches 204 that include one channel type TFTs such as P channel TFTs and N channel TFTs or complementary TFTs. In FIG. 8, one end of each data line 114 is connected to the sampling switch 202, while the other end of each data line 114 is connected to the precharge switch 204. Further, the precharge selection signal NRG generated by the timing control circuit 400 is input to each precharge switch 204, while the precharge signal NRG supplied from the precharge signal supply circuit 500 is input. Each precharge switch 204 supplies the precharge signal NRG for the corresponding data line 114 in response to the precharge selection signal NRG.

Here, in the second embodiment, for the sampling circuit 200, a sampling signal Si is input from the data line driving circuit 101 to the sampling switches belonging to one group, respectively. Further, the sampling switch 202 belonging to one group samples the image signal VIDk in response to the sampling signal Si and supplies it for the corresponding data line 114.

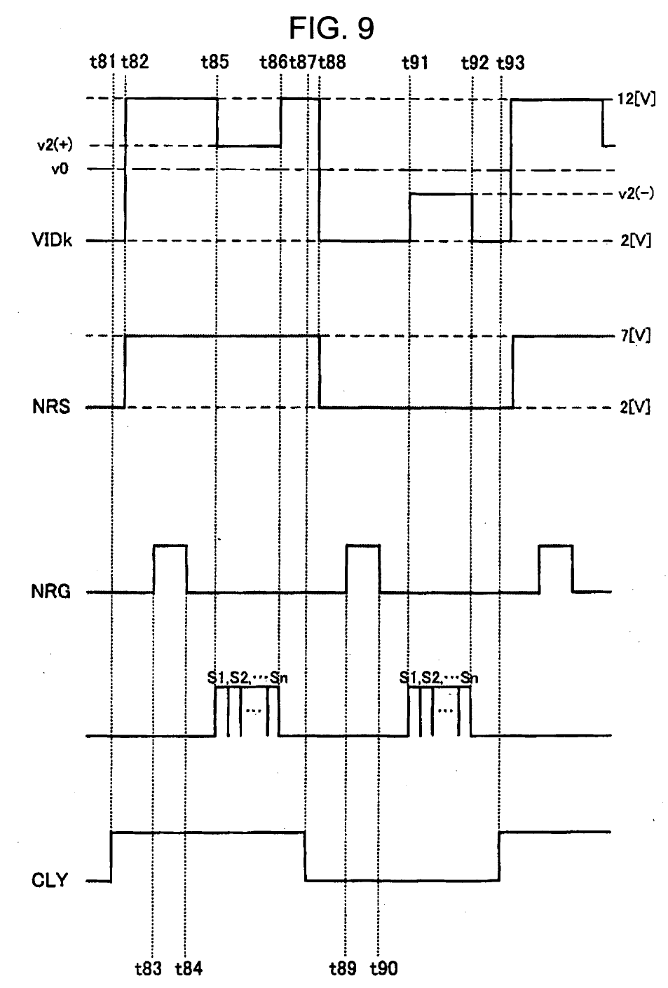

Next, operation of the liquid crystal device according to the second embodiment of the invention is described with reference to FIGS. 7 to 9. FIG. 9 is a timing chart showing a temporal change of various signals based on operation of the liquid crystal device according to the second embodiment of the invention.

In the second embodiment, a plurality of scanning lines 112 are selected one after another based on the arrangement direction of FIG. 8, and performs a normally white mode of display with the liquid crystal device 118, as in the first embodiment. In the following explanation, in particular, the pixel unit 70 corresponding to the (j-1)th and the jth selected scanning lines 112 is focused. In addition, in FIG. 9, the display potential of the image signal VIDk for displaying black color with the liquid crystal device 118 is set to be a positive polarity of 12V and a negative polarity of 2V. In addition, the voltage of the precharge signal NRS is a voltage of 5V specified by a potential of 2V and a potential of 7V for positive and negative polarities, respectively.

In FIG. 9, when the Y clock signal CLY arises from a low level to a high level at the timing t81, the (j-1)th scanning line 112 is selected. When the Y clock signal CLY is in the high level, the (j-1)th scanning line 112 is in a selection state for a period from the time t81 to t87, so that the pixel unit 70 corresponding to the (j-1)th scanning line 112 is selected.

The timing control circuit 400 supplies the precharge selection signal NRG at the timing t83. In addition, the image signal supply circuit 300 inverts the voltage polarity of the image signal VIDk from the negative polarity to the positive polarity at the timing t82 for a period after the time t81 and before the time t83. The potential of the image signal VIDk of 2V is changed into the potential of 12V with a center of the reference potential v0, accompanied by the polarity inversion.

Further, the precharge signal supply circuit 500 inverts the voltage polarity of the precharge signal NRS from the negative polarity to the positive polarity at the timing t82 for a period after the time 81 and before the time t83. The potential of the precharge signal NRS of 2V is changed into the potential of 7V, accompanied by the polarity inversion. In addition, a timing for inverting the polarities of the precharge signal NRS and the image signal VIDk may be not matched for a period after the time t81 and before the time t83.

The precharge selection signal NRG is supplied to n precharge switches 204 of the precharge circuit 205 in a lump sum. In addition, during a period from the time t83 to t84 in which the precharge selection signal NRG is supplied, the n precharge switches 204 turn on in a lump sum, so that a precharge period is selected.

The precharge signal supply circuit 500 supplies the precharge signal NRS of the positive voltage for the n precharge switch 204 during the precharge period. Each precharge switch 204 supplies the precharge signal NRS for the corresponding data line 114. With this, the n data lines 114 are precharged in a lump sum.

After the precharge period ends at the timing t84, at the timing t85, the sampling signal Si is supplied from the data line driving circuit 101 and supplied for the sampling switch 202 of the sampling circuit 200. In addition, during a period from the time t85 to t86 in which the sampling signal Si is supplied, the sampling switch 202 turns on, so that the image signal supply period is specified. During the image signal supply period, each image signal VIDk is supplied for the pixel unit 70 corresponding to the drive data line 114 and further corresponding to the (j-1)th scanning line 112, as in the first embodiment.

After that, the selection of the pixel unit 70 corresponding to the (j-1)th scanning line 112 ends at the timing t87, and at the same time, the jth scanning line 112 is selected. When the jth scanning line 112 is selected, for a period from the time t87 to t93, the pixel unit 70 corresponding to the jth scanning line 112 is selected.

For a selection period of the jth scanning line 112, the precharge selection signal NRG is supplied from the timing control circuit 40 during a period from the time t89 to t90, and then, the sampling signal Si is supplied from the data line driving circuit 101 during a period from the time t91 to t92, as in the selection period of the (j-1)th scanning line 112. With this, the n data lines 114 are precharged during the precharge period in a lump sum, and the pixel unit 70 corresponding to the drive data line 114 and further corresponding to the jth scanning line 112 display images during the image signal supply period.

Here, the image signal supply circuit 300 inverts the voltage polarity of the image signal VIDk from the positive polarity to the negative polarity at the timing t88 for a period after the time t87 and before the time t89. The potential of the image signal VIDk of 12V is changed into the potential of 2V with a center of the reference potential v0, accompanied by the polarity inversion. In addition, the precharge signal supply circuit inverts the voltage polarity of the precharge signal NRS from the positive polarity to the negative polarity at the timing t88 for a period after the time t87 and before the time t89. The potential of the precharge signal NRS of 7V is changed into the potential of 2V, accompanied by the polarity inversion.

Therefore, for the (j-1)th and the jth selected scanning lines 112, under the state that the selection of the pixel unit 70 corresponding to the (j-1)th scanning line 112 ends, the precharge signal supply circuit 500 inverts the voltage polarity of the precharge signal NRS, and the image signal supply circuit 300 inverts the voltage polarity of the image signal VIDk. Thus, it can be prevented that the AC component of the precharge signal NRS or the image signal VIDk supplied for the corresponding data line through the capacitive coupling of the precharge switch 204 or the sampling switch 202 is written to the pixel unit 70 corresponding to the (j-1)th scanning line 112.

In addition, the n data lines 11 4 are precharged in a lump sum during the precharge period, so that it is possible that the image signal VIDk is written to each data line 114 during the image signal supply period in a relatively short time.

In addition, according to the second embodiment, for a time after the start of the precharge period and around the start of the precharge period, the precharge signal supply circuit 500 may invert the voltage polarity of the precharge signal NRS, while the image signal supply circuit 300 may inverts the voltage polarity of the image signal VIDk. With this, the retrace time can be reduced. Alternatively, the precharge period can be arranged within a short retrace time. Here, in FIG. 9, for a period from the time t82 to t85 of a selection period of the (j-1)th scanning line 112, and for a period from the time t88 to t91 of a selection time of the jth scanning line 112 correspond to the retrace time.

3: Electronic Apparatus

A case where the liquid crystal device described above is applied to various electronic apparatuses is described.

3-1: Projector

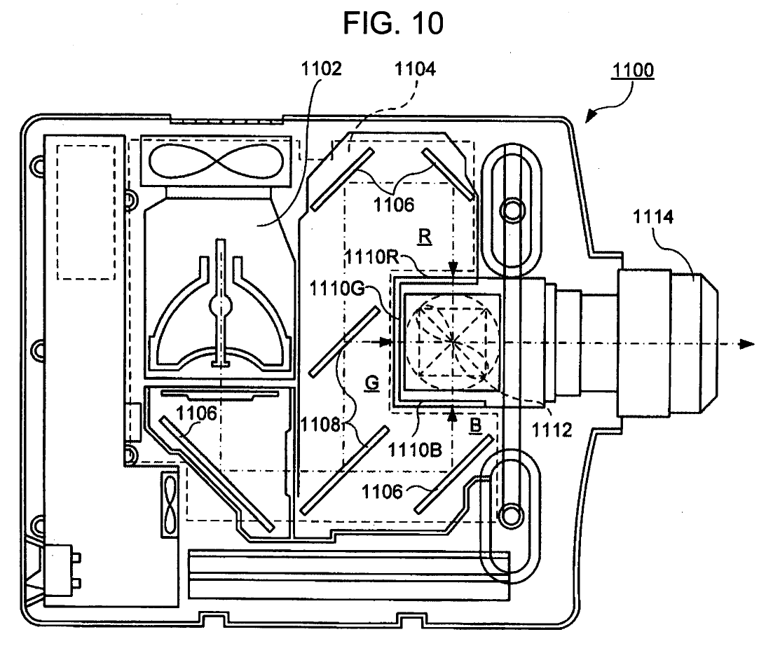

First, a projector using the liquid crystal device as a light valve is described. FIG. 10 is a plan view showing an exemplary arrangement of the projector. As shown in FIG. 10, a lamp unit 1102 made of a white light source such as a halogen lamp is arranged inside a projector 1100. Transmission light emitted from the lamp unit 1102 is separated into 3 primary colors of RGB by four mirrors 1105 and 2 dichroic mirrors 1108 located in a light guide, each of which is incident into light valves 1110R, 1110B and 1110G corresponding to each primary color. These three light valves 1110R, 1110G and 1110B are arranged with a liquid crystal module including the liquid crystal device, respectively.

The R, G, and B primary color signals supplied from the image signal supply circuit 300 drive the liquid crystal panel 100 for the light valves 1110R, 1110B and 1110G, respectively. Further, light modulated by the liquid crystal panel 100 is incident into a dichroic prism 1112 from 3 directions. For the dichroic prism 112, light having R and B color is tilted 90 degrees while light having G color goes straight. Therefore, as a result of a combination of the images of each color, a color image is illuminated on a screen through a projection lens 1114.

Here, focusing on the display image by each light valve 1110R, 1110B and 1110G, it is necessary for the display image by the light valve 1110G to be left side to the right win the respect to the display image by the light valves 1110R and 1110B.

In addition, light corresponding to each primary color of R, G, and B is incident to the light valves 1110R, 1110B and 1110G by the dichroic mirror 1108, so that it is not necessary that a color filter should be arranged.

3-2: Mobile Computer

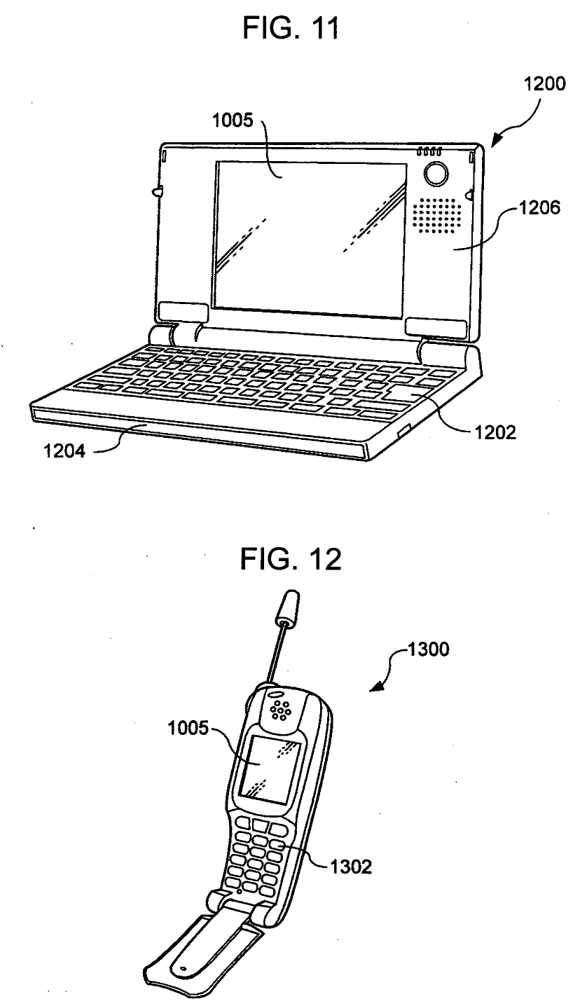

An example in which the liquid crystal device is applied to a mobile type personal computer is described. FIG. 11 is a perspective view showing an arrangement of the personal computer. In FIG. 11, a computer 1200 includes a main unit 1204 having a keyboard 1202 and a liquid crystal unit 1206. The liquid crystal unit 1206 is arranged on the back side of the liquid crystal device 1005 described above by adding a backlight unit.

3-3: Mobile Phone

Further, an example in which the liquid crystal device is applied to a mobile phone is described. FIG. 12 is a perspective view showing an arrangement of the mobile phone. In FIG. 12, the mobile phone 1300 has a reflection type liquid crystal device 1005 along with a plurality of control buttons 1302. The reflection type liquid crystal device 1005 has a front light unit on a front side, if required.

Further, in addition to the electronic apparatuses described with reference to FIGS. 10 to 12, there can be provided apparatuses including a liquid crystal TV, a view finder type, a monitor direct view type video tape recorder, a car navigation apparatus, a pager, an electronic notepad, a calculator, a word processor, a workstation, a TV telephone, a POS terminal, and a touch panel. Further, it is useless to say that these various electronic apparatuses can also be applied.

The invention is not limited to the embodiments described above, but various modifications can be made without departing from the spirit and idea of the invention, which can be read throughout claims and specifications. Thus, an electro-optical device modified like this, and an electronic apparatus having the electro-optical device are also included in the scope of the invention.

1. An electro-optical device comprising:
a plurality of scanning lines;
a plurality of data lines;
a plurality of pixel units that are electrically connected to the scanning lines and the data lines, respectively, and have display elements, respectively;
a plurality of selection switching elements that supply image signals to the data lines, in response to selection signals;
a scanning line driving circuit that supplies scanning signals for line-sequentially selecting the plurality of scanning lines to the plurality of scanning lines, respectively;
a selection signal supply circuit that, for one scanning line to which the scanning signal is supplied relatively earlier and another scanning line to which the scanning line is supplied relatively later among the plurality of scanning lines, supplies the selection signal to each of the selection switching elements after the supply of the scanning signal to the one scanning line ends and another scanning line is selected by the supply of the scanning signal; and
an image signal supply circuit that, after the supply of the scanning signal to the one scanning line ends, supplies the image signal to each of the selection switching elements, wherein a period in which the voltage polarity of the image signal is inverted into one of a first polarity and a second polarity with respect to a predetermined reference potential corresponds to a time until another scanning line is selected and the supply of the selection signal starts.

2. The electro-optical device according to claim 1,
wherein the selection signal supply circuit supplies;
a batch of precharge selection signals to the plurality of selection switching elements, the batch of precharge selection signal specifying a precharge period during a period when another scanning line is selected; and
image signal supply selection signals to the selection switching element corresponding to one or more of simultaneously driven data lines, the image signal specifying an image signal supply period of one or the plurality of simultaneously driven data lines among the plurality of data lines, after the precharge period elapses, and
wherein the image signal supply circuit inverts the voltage polarity of the image signal until the start of the precharge period after another scanning line is selected, while supplying the image signal as a precharge signal having a predetermined precharge potential during the precharge period and as an image signal having a display potential adjusted for each of the data lines during the image signal supply period.

3. The electro-optical device according to claim 1, further comprising:
a plurality of precharge selection switching elements that supply a batch of precharge signals to the plurality of data lines in response to a precharge selection signal that specifies the precharge period; and
a precharge signal supply circuit that supplies to each of the precharge selection switching elements the precharge signal at least during the precharge period by inverting a voltage of the precharge signal into one of the first polarity and the second polarity corresponding to the voltage polarity of the image signal until the start of the precharge period after another scanning line is selected;
the selection signal supply circuit supplies;
a batch of the precharge selection signals to the plurality of precharge selection switching elements, the batch of precharge selection signals specifying a precharge period during a period when another scanning line is selected;
image signal supply selection signals to the selection switching element corresponding to one or more of simultaneously driven data lines, the image signal specifying an image signal supply period of one or the plurality of simultaneously driven data lines among the plurality of data lines, after the precharge period elapses, and wherein the image signal supply circuit inverts the voltage polarity of the image signal until the start of the precharge period after another scanning line is selected, while supplying the image signal as a precharge signal having a predetermined precharge potential during the precharge period and as an image signal having a display potential adjusted for each of the data lines during the image signal supply period.

4. An electro-optical device comprising:
a plurality of scanning lines;
a plurality of data lines;
a plurality of pixel units that are electrically connected to the scanning lines and the data lines, respectively, and have display elements, respectively;
a plurality of selection switching elements that supply image signals for the data lines, in response to selection signals;
a scanning line driving circuit that supplies scanning signals for line-sequentially selecting the plurality of scanning lines to the plurality of scanning lines, respectively;
a selection signal supply circuit that, for one scanning line to which the scanning signal is supplied relatively earlier and another scanning line to which the scanning line is supplied relatively later among the plurality of scanning lines, supplies, as the selection signal, to the plurality of selection switching elements a batch of precharge selection signals that specify a precharge period during a period that the supply of the scanning signal to the first scanning line ends and another scanning signal is selected by the supply of the scanning signal, while supplying, as the selection signal, to the selection switching element corresponding to one or more of simultaneously driven data lines image signal supply selection signals that specify an image signal supply period of the one or more of simultaneously driven data lines among the plurality of data lines, after the precharge period elapses; and
an image signal supply circuit that inverts voltage polarity of the image signal into either a first polarity or a second polarity with respect to a predetermined reference potential at the start of the precharge period while supplying the image signal to each of the selection switching elements as a precharge signal having a predetermined precharge potential during the precharge period and as an image signal having a display potential adjusted for each of the data lines during the image signal supply period.

5. The electro-optical device according to claim 1,
wherein each of the pixel units includes a pixel switching element that switch-controls each of the display elements,
the display elements are provided opposite to pixel electrodes, an electro-optical material is interposed between counter electrode and the pixel electrodes, the counter electrode serving as common potentials,
the pixel switching element supplies to the pixel electrode the image signal supplied from the data line in response to the scanning signal supplied from the scanning line, and
the display element performs image display based on the image signal.

6. An electronic apparatus comprising an electro-optical device according to claim 1.
